(19) United States
(12) Patent Application Publication
(10) Pub. No.: US 2015/0302445 A1
(43) Pub. Date: Oct. 22, 2015

(54) METHOD FOR INTERACTION AND, SERVER AND NETWORK PLATFORM THEREFOR

(71) Applicant: TENCENT TECHNOLOGY (SHENZHEN) COMPANY LIMITED, Shenzhen (CN)

(72) Inventors: Mingming ZHAO, Shenzhen (CN); Jianwei DENG, Shenzhen (CN); Songjian WANG, Shenzhen (CN); Ningguo CHEN, Shenzhen (CN); Ding ZHANG, Shenzhen (CN); Qiang FEI, Shenzhen (CN); Chaofan ZHOU, Shenzhen (CN); Huifang YI, Shenzhen (CN); Peng YE, Shenzhen (CN)

(21) Appl. No.: 14/791,232

(22) Filed: Jul. 2, 2015

Related U.S. Application Data
(63) Continuation of application No. PCT/CN2013/088893, filed on Dec. 9, 2013.

(30) Foreign Application Priority Data
Jan. 11, 2013 (CN) 201310011207.4

(51) Int. Cl. G06Q 30/02; H04L 29/06; G06Q 50/00; H04L 29/08

(52) U.S. Cl. CPC G06Q 30/0214; H04L 67/02; H04L 67/42; G06Q 50/01

(57) ABSTRACT

Disclosed are a method for interaction, and a server and a network platform therefor. The method includes: acquiring a task link that is clicked by a user on a first network platform from the first network platform; and redirecting, according to the task link, to a webpage where the preset task on the second network platform is located, such that the user performs the preset task on the second network platform on the webpage. The server includes a first acquiring module and a redirecting module. The server redirects, according to a task link clicked by a user on a first platform, to a webpage where a preset task on a second network platform is located, which implements interaction between the user and multiple network platforms, and thereby provides more ways in which the user interacts with the network platforms.

### CROSS-REFERENCE TO RELATED APPLICATION

This application is a continuation application of PCT Patent Application No. PCT/CN2013/088893, filed on Dec. 9, 2013, which is based upon and claims the benefit of priority from Chinese Patent Application No. 201310011207.4, filed on Jan. 11, 2013, the entire contents of both of which said applications are incorporated herein by reference in their entirety.

### TECHNICAL FIELD

The present disclosure relates to the Internet field, and in particular, to a method for interaction and a server and a network platform therefor.

### BACKGROUND

With the rapid development of the Internet industry, electronic commerce becomes a popular business. The electronic commerce has many available models, for example, Business-to-Business (B2B), Business-to-Consumer (B2C), Consumer-to-Consumer (C2C), and the like. All of these different electronic commerce models depend on various network platforms, where interaction between a user and a network platform is required to achieve a business objective.

when a user interacts with a network platform, first, the user selects and clicks a task link corresponding to a preset task on the network platform by using a terminal; then, a server corresponding to the network platform redirects, according to the task link clicked by the user, to a webpage where the preset task on the network platform is located, such that the user performs the preset task on the webpage. The preset task may be shopping, making a payment, and the like.

During the implementation of the present disclosure, the inventors find that the method has at least the following problems:

When the user interacts with the network platform, because the task link on the network platform is a task link corresponding only to the preset task on the network platform, the user can perform the preset task only on one network platform. This limits, to some extent, the interaction between the user and the network platform.

### SUMMARY

Embodiments of the present disclosure provide a method for interaction and a server and a network platform therefor. The technical solutions are as follows:

In one aspect, a method for interaction is provided. The method includes:

acquiring a task link that is clicked by a user on a first network platform, where the task link corresponds to a preset task on a second network platform;

redirecting, according to the task link, to a webpage where the preset task on the second network platform is located; and

implementing the preset task on the webpage.

In another aspect, a server is provided. The server includes:

a first acquiring module, configured to acquire a task link that is clicked by a user on a first network platform, where the task link corresponds to a preset task on a second network platform; and

a redirecting module, configured to redirect, according to the task link acquired by the first acquiring module, to a webpage where the preset task on the second network platform is located; and implement the preset task on the webpage.

In still another aspect, a method for interaction is provided. The method includes:

displaying at least one task link corresponding to a preset task on a second network platform; and

upon detecting that a user clicks the displayed task link, sending the task link clicked by the user to a server, whereupon the server redirects, according to the task link clicked by the user, to a webpage where the preset task on the second network platform is located, such that the user performs the preset task on the second network platform on the webpage.

In yet still another aspect, a network platform is provided. The network platform includes:

a displaying module, configured to display at least one task link corresponding to a preset task on a second network platform; and

a sending module, configured to: upon detecting that a user clicks the displayed task link, send the task link clicked by the user to a server, whereupon the server redirects, according to the task link clicked by the user, to a webpage where the preset task on the second network platform is located, such that the user performs the preset task on the second network platform on the webpage.

The technical solutions provided in the embodiments of the present disclosure achieve the following beneficial effects:

A server acquires a task link clicked by a user on a first network platform, and directly redirects, according to the task link, to a webpage where a preset task on a second network platform is located, such that the user performs the preset task on the second network platform on the webpage, which implements interaction between the user and multiple network platforms, thereby providing more ways in which the user interacts with the network platforms.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a flowchart of a method for interaction according to an embodiment of the present disclosure;

FIG. 2 is a flowchart of a method for interaction according to an embodiment of the present disclosure;

FIG. 3 is a schematic diagram of a system according to an embodiment of the present disclosure;

FIG. 4 is a schematic structural diagram of a first server according to an embodiment of the present disclosure;

FIG. 5 is a schematic structural diagram of a second server according to an embodiment of the present disclosure;

FIG. 6 is a schematic structural diagram of a third server according to an embodiment of the present disclosure;

FIG. 7 is a schematic structural diagram of a fourth server according to an embodiment of the present disclosure;

FIG. 8 is a schematic structural diagram of a fifth server according to an embodiment of the present disclosure;

FIG. 9 is a schematic structural diagram of a sixth server according to an embodiment of the present disclosure; and

FIG. 10 is a schematic structural diagram of a network platform according to an embodiment of the present disclosure.

### DETAILED DESCRIPTION

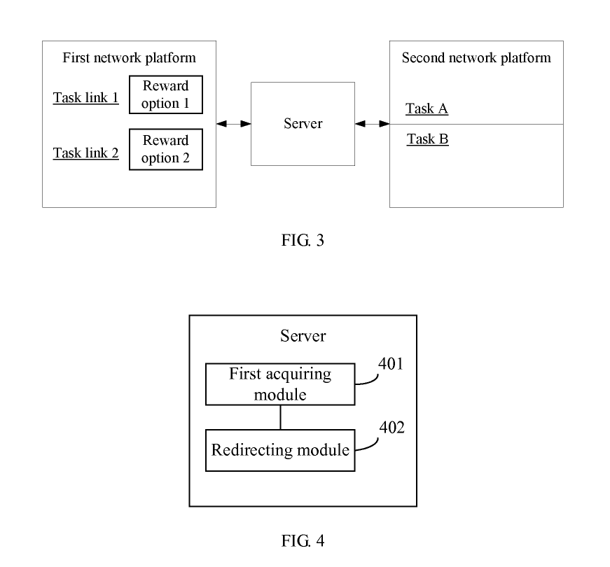

To make the objectives, technical solutions, and advantages of the present disclosure clearer, the embodiments of the present disclosure are described in detail below with reference to the accompanying drawings. An embodiment of the present disclosure provides a method for interaction. For ease of understanding, the method according to this embodiment is described using an implementation environment illustrated in FIG. 3 as an example. As illustrated in FIG. 3, to implement interaction between a user and a plurality of network platforms, the embodiment illustrated in FIG. 3 includes a first network platform, a server, and a second network platform. The first network platform may communicate with the server over a wired network or a wireless network; and the second network platform may also communicate with the server over a wired network or a wireless network.

The first network platform includes but not limited to an online shopping platform, a social network platform, an online game platform, or the like; and the first network platform displays a task link, where the task link corresponds to a preset task on the second network platform. The second network platform may also include but not limited to an online shopping platform, a social network platform, an online game platform, or the like; and the second network platform displays a preset task, where the preset task is a task preset on the second network platform, and each preset task corresponds to a webpage on the second network platform.

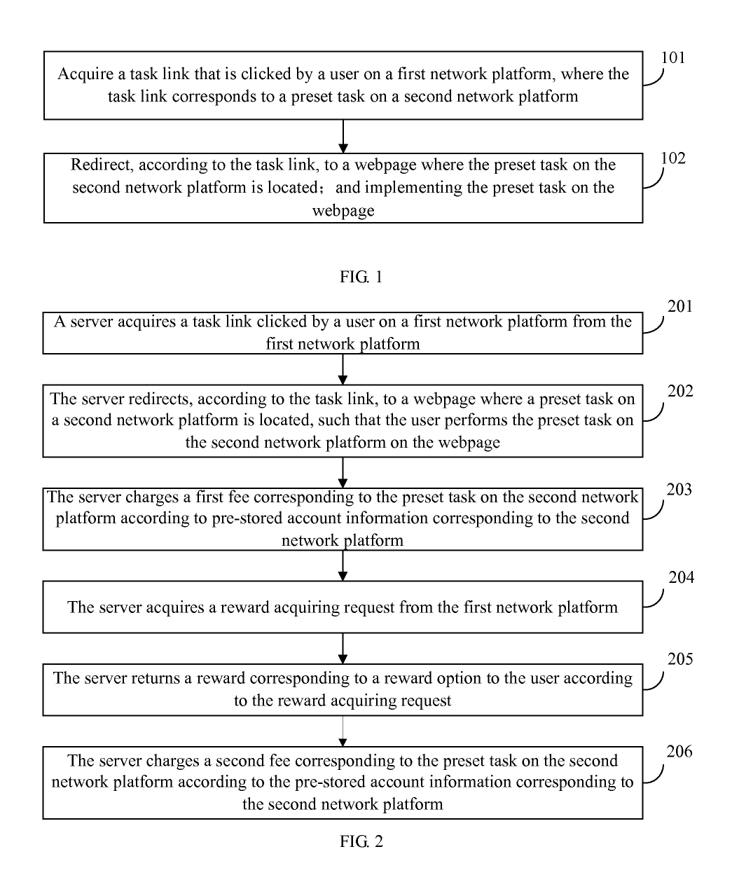

Based on the embodiment illustrated in FIG. 3, referring to FIG. 1, the method according to an embodiment of the present disclosure includes the following steps:

101: acquiring a task link that is clicked by a user on a first network platform, where the task link corresponds to a preset task on a second network platform; and

102: redirecting, according to the task link, to a webpage where the preset task on the second network platform is located; and implementing the preset task on the webpage.

Furthermore, before the redirecting, according to the task link, to a webpage where the preset task on the second network platform is located, the method further includes but is not limited to:

authenticating whether the user is qualified to perform the preset task on the second network platform; and if the user is qualified, sequentially performing the step of redirecting, according to the task link, to the webpage where the preset task on the second network platform is located.

Furthermore, after the redirecting, according to the task link, to a webpage where the preset task on the second network platform is located, the method further includes but is not limited to:

charging a first fee corresponding to the preset task on the second network platform according to pre-stored account information corresponding to the second network platform.

Furthermore, after the redirecting, according to the task link, to a webpage where the preset task on the second network platform is located, the method further includes but is not limited to:

acquiring a reward acquiring request from the first network platform, where the reward acquiring request is generated according to a reward option clicked by the user on the first network platform after performing the preset task on the second network platform, and the reward option corresponds to the preset task on the second network platform; and

returning a reward corresponding to the reward option to the user according to the reward acquiring request.

Furthermore, before the returning a reward corresponding to the reward option to the user according to the reward acquiring request, the method further includes but is not limited to:

authenticating whether the user is qualified to acquire the reward corresponding to the reward option; and if the user is qualified, sequentially performing the step of returning the reward corresponding to the reward option to the user according to the reward acquiring request.

Furthermore, after the returning a reward corresponding to the reward option to the user according to the reward acquiring request, the method further includes but is not limited to:

charging a second fee corresponding to the preset task on the second network platform according to the pre-stored account information corresponding to the second network platform. It should be noted that, according to this embodiment and the subsequent embodiments of the present disclosure, either one or a plurality of first network platforms or second network platforms may be used, and the number of first network platforms or second network platforms is not limited in various embodiments of the present disclosure. When a plurality of first network platform or second network platforms are used, a method for interaction is analogous in terms of principles to the method for interaction according to this embodiment, which is not described herein any further.

According to the above description, in the method according to this embodiment, since a task link on a first network platform corresponds to a preset task on a second network platform and the preset task on the second network platform further corresponds to a webpage on the second network platform, a task link clicked by a user on the first network platform is acquired and a server redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms.

In order to extent manners in which a user interacts with a network platform, an embodiment of the present disclosure provides a method for interaction. With reference to the content of the embodiments described above, referring to FIG. 2, the method includes the following steps:

201: A server acquires a task link clicked by a user on a first network platform from the first network platform.

The first network platform may be an online shopping platform, a social network platform, an online game platform, or in other forms. The first network platform displays the task link, where the task link corresponds to a preset task on a second network platform. The task link may be displayed as an address link, an image icon, text, or in other forms. This embodiment of the present disclosure sets no specific limitation on the first network platform and the display manner of the task link herein.

It should be noted that the first network platform may display multiple task links, where each task link corresponds to one preset task on the second network platform. The first network platform may sort the multiple displayed task links according to a preset sorting criterion. There may be one or more second network platforms. The preset sorting criterion may be update date, popularity, corresponding reward amount of the preset task on the second network platform corresponding to the multiple task links, or other sorting criteria. This embodiment of the present disclosure sets no specific limitation on the sorting criterion of the multiple links herein. The user may select and click one task link of the multiple task links displayed on the first network platform. The first network platform sends the task link to the server upon detecting that the user clicks the task link.

For example, as illustrated in FIG. 3, the first network platform displays a task link 1 and a task link 2, where the task link 1 corresponds to a task A on the second network platform, and the task link 2 corresponds to a task B on the second network platform. The user selects and clicks the task link 1 of the task link 1 and task link 2 displayed on the first network platform. The first network platform sends the task link 1 to the server upon detecting that the user clicks the task link 1.

202: The server redirects, according to the task link, to a webpage where the preset task on the second network platform is located, such that the user performs the preset task on the second network platform on the webpage.

The second network platform may be an online shopping platform, a social network platform, an online game platform, or in other forms. The preset task is a task preset by the second network platform. Each preset task corresponds to one webpage on the second network platform. The preset task may be shopping, making payment, playing a game, installing an application, or in other forms. This embodiment of the present disclosure sets no specific limitation on the form of the second network platform and the form of the preset task.

For example, as illustrated in FIG. 3, the server redirects, according to the task link 1, to a webpage where the preset task A on the second network platform is located, such that the user performs the preset task A on the second network platform on the webpage.

Moreover, before the server redirects, according to the task link, to the webpage where the preset task on the second network platform is located, the method further includes but is not limited to the following step: authenticating whether the user is qualified to perform the preset task on the second network platform; and if the user is qualified, sequentially performing the step of redirecting, according to the task link, to the webpage where the preset task on the second network platform is located.

A criterion for authenticating whether the user is qualified to perform the preset task on the second network platform may be determining whether the user logs in and determining whether the user performs the preset task on the second network platform for the first time; and if the user logged in but did not perform the preset task, determining that the user is qualified to perform the preset task on the second network platform. The server pre-stores login data of the user and a record of performing the preset task on the second network platform by the user. Besides the criterion described above, other criteria may also be adopted to authenticate whether the user is qualified to perform the preset task on the second network platform. This embodiment of the present disclosure sets no specific limitation on the criterion for authenticating whether the user is qualified to perform the preset task on the second network platform.

It should be noted that if it is determined that the user is not qualified to perform the preset task on the second network platform, the server returns prompt information to the first network platform, and the first network platform displays the prompt information to the user, such that the user may give up, upon learning, according to the prompt information, that the user is not qualified to perform the preset task on the second network platform, performing the preset task on the second network platform, or take corresponding measures to be qualified to perform the preset task on the second network platform. Nevertheless, other processing may also be adopted, where this embodiment sets no specific limitation thereto. In addition, through steps 201 and 202, the user on the first network platform is guided to the second network platform to perform the preset task. In practice, the first network platform and the second network platform may be different network platforms provided by different sellers, and the user on the first network platform is guided to the second network platform to perform the preset task, thereby making advertisement and commercial promotions for the seller of the second network platform. Accordingly, after the user on the first network platform is guided to the second network platform to perform the preset task, the method according to this embodiment further includes a step of charging a corresponding fee. The specific fee charging mode may be described in the subsequent steps.

203: The server charges a first fee corresponding to the preset task on the second network platform according to pre-stored account information corresponding to the second network platform.

The account information corresponding to the second network platform may be bank card information of a seller on the second network platform, account information of an online payment platform, and the like. This embodiment of the present disclosure sets no specific limitation on the account information corresponding to the second network platform. A specific amount of the first fee may be negotiated by the second network platform and the first network platform and be provided in the server in advance. Each preset task corresponds to one first fee. After the server redirects, according to the task link, to the webpage where the preset task on the second network platform is located in step 202, the server successfully directs the user from the first network platform to the second network platform, hence may charge the first fee corresponding to the preset task on the second network platform from the pre-stored account information of the second network platform.

Specifically, the second network platform and the first network platform may negotiate in advance a total fee corresponding to the preset task on the second network platform and provide the total fee in the server; after the server successfully directs the user from the first network platform to the second network platform, the server charges the first fee corresponding to the preset task on the second network platform according to the pre-stored account information of the second network platform, where the first fee is a fee of a first percentage of the total fee. The first percentage may be 40%, 50%, and the like. This embodiment of the present disclosure sets no limitation on a specific value of the first percentage.

204: The server acquires a reward acquiring request from the first network platform.

The reward acquiring request is generated according to a reward option clicked by the user on the first network platform after performing the preset task on the second network platform, and the reward option corresponds to the preset task on the second network platform. The first network platform displays the reward option, so as to prompt the user to click the reward option to acquire a corresponding reward.

With respect to this step, before the server acquires the reward acquiring request from the first network platform, the user returns to the first network platform after performing the preset task on the second network platform, and then clicks the reward option; the first network platform sends the corresponding reward acquiring request to the server according to the reward option clicked by the user. The reward acquiring request may carry an identifier corresponding to the reward option, and the server acquires from the first network platform the reward acquiring request carrying the identifier corresponding to the reward option.

It should be noted that when the first network platform displays multiple task links, the first network platform also displays multiple reward options, and the first network platform may sort the multiple displayed reward options according to a preset sorting criterion. The preset sorting criterion may be a completion rate of the preset task on the second network platform corresponding to the multiple reward options, an amount of the reward corresponding to the multiple reward options, or other sorting criteria. This embodiment of the present disclosure sets no specific limitation on the sorting criterion of the multiple reward options. The user may select and click one reward option of the multiple reward options displayed on the first network platform, and the first network platform sends a corresponding reward acquiring request to the server according to the reward option clicked by the user.

For example, as illustrated in FIG. 3, the user returns to the first network platform after performing the preset task A on the second network platform, and clicks a reward option 1; the first network platform sends a reward acquiring request to the server according to the reward option 1 clicked by the user, where the reward acquiring request carries an identifier 1 corresponding to the reward option 1; and the server acquires from the first network platform the reward acquiring request carrying the identifier 1 corresponding to the reward option 1.

205: The server returns a reward corresponding to the reward option to the user according to the reward acquiring request.

Specifically, the server determines a reward corresponding to the identifier according to the identifier, carried in the reward acquiring request, corresponding to the reward option, and returns the reward corresponding to the identifier to the user. The reward corresponding to the reward option may be a point reward, a shopping ticket reward, an actual material reward, and the like, on the first network platform. This embodiment of the present disclosure sets no specific limitation on the reward corresponding to the reward option.

For example, the server determines a reward 1 corresponding to an identifier 1 according to the identifier 1, carried in the reward acquiring request, corresponding to the reward option 1, and returns the reward 1 corresponding to the identifier 1 to the user.

Moreover, before the server returns the reward corresponding to the reward option to the user according to the reward acquiring request, the method further includes but is not limited to the following step: authenticating whether the user is qualified to acquire the reward corresponding to the reward option; and if the user is qualified, sequentially performing the step of returning the reward corresponding to the reward option to the user according to the reward acquiring request.

A criterion for authenticating whether the user is qualified to acquire the reward corresponding to the reward option may be determining whether the user performs the preset task on the second network platform for the first time, whether the user finishes performing the preset task on the second network platform, and whether the preset task on the second network platform is overdue; and determining that the user is qualified to acquire the reward corresponding to the reward option if the user performs and finishes the preset task on the second network platform for the first time and the preset task on the second network platform is not overdue. The server pre-stores the record of performing the preset task on the second network platform by the user and duration of the preset task on the second network platform. Besides the criterion described above, other criteria may also be adopted to authenticate whether the user is qualified to acquire the reward corresponding to the reward option. This embodiment of the present disclosure sets no specific limitation on the criterion for authenticating whether the user is qualified to acquire the reward corresponding to the reward option.

It should be noted that, if the user is not qualified to acquire the reward corresponding to the reward option, the server returns prompt information to the first network platform; and the first network platform displays the prompt information to the user such that the user may give up, upon learning, according to the prompt information, that the user is not qualified to acquire the reward corresponding to the reward option, acquiring the reward, or take corresponding measures to be qualified to acquire the reward. Nevertheless, other processing may also be adopted, where this embodiment sets no specific limitation thereto.

206: The server charges a second fee corresponding to the preset task on the second network platform according to the pre-stored account information corresponding to the second network platform.

The account information corresponding to the second network platform may be bank card information of a seller on the second network platform, account information of an online payment platform, and the like. This embodiment of the present disclosure sets no specific limitation on the account information corresponding to the second network platform. A specific amount of the second fee may be negotiated by the second network platform and the first network platform and be provided in the server in advance. Each preset task corresponds to one second fee. After the server returns the reward corresponding to the reward option to the user according to the reward acquiring request in step 205, the server determines that the user directed from the first network platform to the second network platform finishes performing the preset task on the second network platform, and hence may charge the second fee corresponding to the preset task on the second network platform from the pre-stored account information of the second network platform.

Specifically, the server charges, upon determining that the user directed from the first network platform to the second network platform finishes performing the preset task on the second network platform, charges the second fee corresponding to the preset task on the second network platform from the pre-stored account information of the second network platform, where the second fee is a fee remaining in the total fee after the first fee is charged.

It should be noted that, a charging mode available in the prior art is a Cost Per Thousand Impressions (CPM) manner, that is, charging by a unit price of every thousand users viewing an advertisement presented on a network platform, or a Cost Per Sales (CPS) manner, that is, charging according to the actual number of sold products. Each of the charging modes provided by the prior art is charging according only to one fixed criterion, and separate charging respectively before and after task interaction is completed between network platforms is not considered. According to this embodiment of the present disclosure, the charging rules of step 203 and step 206 may ensure that the first fee is charged from the second network platform only after the server directs the user from the first network platform to the second network platform, and the second fee is charged only after the user finishes performing the preset task on the second network platform. This charging mode is more proper.

According to the above description, in the method according to this embodiment, since a task link on a first network platform corresponds to a preset task on a second network platform and the preset task on the second network platform further corresponds to a webpage on the second network platform, a task link clicked by a user on the first network platform is acquired and a server redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms. In addition, fees of the second network platform respectively are further charged after the user redirects to the second network platform according to the task link and after the user performs the preset task on the second network platform, thereby providing more charging modes between the network platforms.

This embodiment of the present disclosure provides a server, where the server is configured to perform the method for interaction according to the embodiments described above. Referring to FIG. 4, the server includes:

a first acquiring module 401, configured to acquire a task link that is clicked by a user on a first network platform, where the task link corresponds to a preset task on a second network platform; and

a redirecting module 402, configured to redirect, according to the task link acquired by the first acquiring module 401, to a webpage where the preset task on the second network platform is located; and implement the preset task on the webpage.

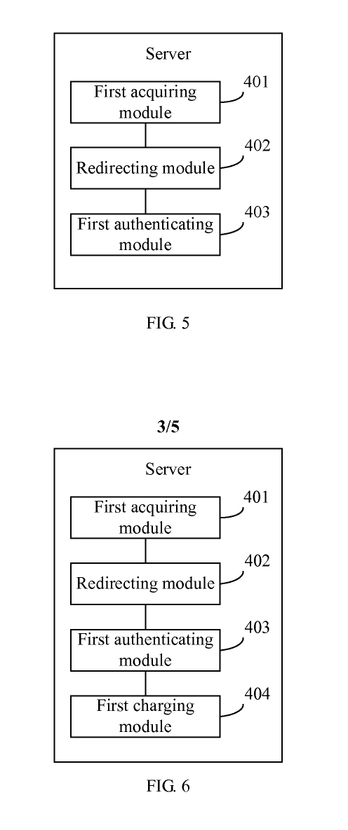

Furthermore, referring to FIG. 5, the server further includes:

a first authenticating module 403, configured to authenticate whether the user is qualified to perform the preset task on the second network platform; and if the user is qualified, the redirecting module performs the step of redirecting, according to the task link, to the webpage where the preset task on the second network platform is located.

Furthermore, referring to FIG. 6, the server further includes:

a first charging module 404, configured to charge a first fee corresponding to the preset task on the second network platform according to pre-stored account information corresponding to the second network platform.

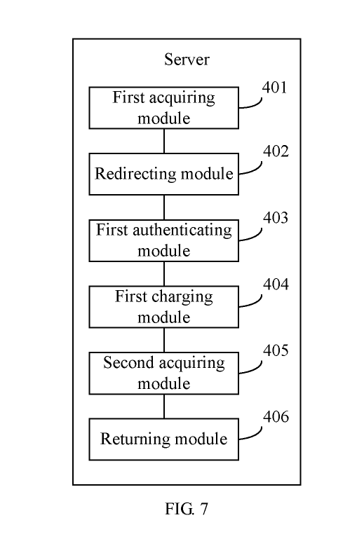

Furthermore, referring to FIG. 7, the server further includes:

a second acquiring module 405, configured to acquire a reward acquiring request from the first network platform, where the reward acquiring request is generated according to a reward option clicked by the user on the first network platform after performing the preset task on the second network platform, and the reward option corresponds to the preset task on the second network platform; and

a returning module 406, configured to return a reward corresponding to the reward option to the user according to the reward acquiring request acquired by the second acquiring module 405.

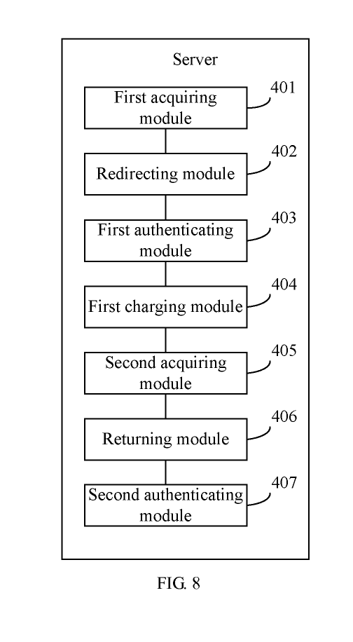

Furthermore, referring to FIG. 8, the server further includes:

a second authenticating module 407, configured to authenticate whether the user is qualified to acquire the reward corresponding to the reward option; and if the user is qualified, the returning module performs the step of returning the reward corresponding to the reward option to the user according to the reward acquiring request.

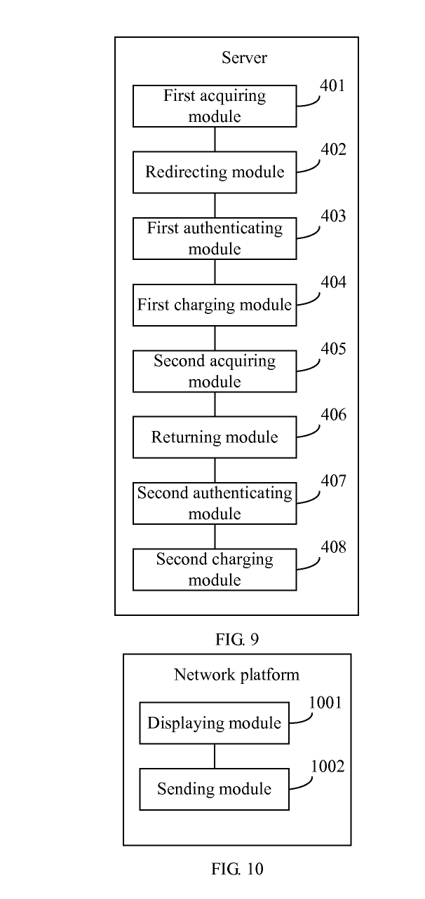

Furthermore, referring to FIG. 9, the server further includes:

a second charging module 408, configured to charge a second fee corresponding to the preset task on the second network platform according to the pre-stored account information corresponding to the second network platform.

According to the above description, since a task link on a first network platform corresponds to a preset task on a second network platform and the preset task on the second network platform further corresponds to a webpage on the second network platform, the server according to this embodiment acquires a task link clicked by a user on the first network platform and redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms. In addition, fees of the second network platform respectively are further charged after the user redirects to the second network platform according to the task link and after the user performs the preset task on the second network platform, thereby providing more charging modes between the network platforms.

An embodiment of the present disclosure provides a server. The server includes a memory and at least one program, where the at least one program is stored in the memory, and is configured to be executed by at least one processor. The at least one program includes instructions for performing the following operations:

acquiring a task link that is clicked by a user on a first network platform, where the task link corresponds to a preset task on a second network platform; and

redirecting, according to the task link, to a webpage where the preset task on the second network platform is located; and implementing the preset task on the webpage.

Optionally, the memory further includes an instruction for performing the following operation:

Prior to the redirecting, according to the task link, to the webpage where the preset task on the second network platform is located, authenticating whether the user is qualified to perform the preset task on the second network platform; and if the user is qualified, sequentially performing the step of redirecting, according to the task link, to the webpage where the preset task on the second network platform is located.

Optionally, the memory further includes an instruction for performing the following operation:

after redirecting, according to the task link, to the webpage where the preset task on the second network platform is located, charging a first fee corresponding to the preset task on the second network platform according to pre-stored account information corresponding to the second network platform.

Optionally, the memory further includes instructions for performing the following operations:

after redirecting, according to the task link, to the webpage where the preset task on the second network platform is located, acquiring a reward acquiring request from the first network platform, where the reward acquiring request is generated according to a reward option clicked by the user on the first network platform after performing the preset task on the second network platform, and the reward option corresponds to the preset task on the second network platform.

returning a reward corresponding to the reward option to the user according to the reward acquiring request.

Optionally, the memory further includes an instruction for performing the following operation:

prior to the returning the reward corresponding to the reward option to the user according to the reward acquiring request, authenticating whether the user is qualified to acquire the reward corresponding to the reward option; and if the user is qualified, sequentially performing the step of returning the reward corresponding to the reward option to the user according to the reward acquiring request.

Optionally, the memory further includes an instruction for performing the following operation:

after returning a reward corresponding to the reward option to the user according to the reward acquiring request, charging a second fee corresponding to the preset task on the second network platform according to the pre-stored account information corresponding to the second network platform.

According to the above description, since a task link on a first network platform corresponds to a preset task on a second network platform and the preset task on the second network platform further corresponds to a webpage on the second network platform, the server according to this embodiment acquires a task link clicked by a user on the first network platform and redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms. In addition, fees of the second network platform respectively are further charged after the user redirects to the second network platform according to the task link and after the user performs the preset task on the second network platform, thereby providing more charging modes between the network platforms.

An embodiment of the present disclosure provides a network platform. Referring to FIG. 10, the network platform includes:

a displaying module 1001, configured to display at least one task link corresponding to a preset task on a second network platform; and

a sending module 1002, configured to: upon detecting that a user clicks the displayed task link, send the task link clicked by the user to a server, whereupon the server redirects, according to the task link clicked by the user, to a webpage where the preset task on the second network platform is located, such that the user performs the preset task on the second network platform on the webpage.

Optionally, the displaying module 1001 is further configured to display at least one reward option corresponding to the preset task on the second network platform; and

the sending module 1002 is further configured to send a reward acquiring request to the server according to the reward option clicked by the user, such that the server returns a reward corresponding to the reward option according to the reward acquiring request.

According to the above description, since a task link on a first network platform corresponds to a preset task on a second network platform and the preset task on the second network platform further corresponds to a webpage on the second network platform, the network platform according to this embodiment, upon detecting that a user clicks a displayed task link, sends the task link clicked by the user to a server, and the server redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms.

An embodiment of the present disclosure provides a network platform. The network platform includes a memory and at least one program, where the at least one program is stored in the memory, and is configured to be executed by at least one processor. The at least one program includes instructions for performing the following operations:

displaying at least one task link corresponding to a preset task on a second network platform; and

upon detecting that a user clicks the displayed task link, sending the task link clicked by the user to a server, whereupon the server redirects, according to the task link clicked by the user, to a webpage where the preset task on the second network platform is located, such that the user performs the preset task on the second network platform on the webpage.

Optionally, the memory further includes instructions for performing the following operations:

displaying at least one reward option corresponding to the preset task on the second network platform; and

after the sending the task link clicked by the user to a server, sending a reward acquiring request to the server according to the reward option clicked by the user, such that the server returns a reward corresponding to the reward option according to the reward acquiring request.

According to the above description, since a task link on a first network platform corresponds to a preset task on a second network platform and the preset task on the second network platform further corresponds to a webpage on the second network platform, the network platform according to this embodiment, upon detecting that a user clicks a displayed task link, sends the task link clicked by the user to a server, and the server redirects, according to the task link, to a webpage where the preset task on the second network platform is located, such that the user performs the preset task on the second network platform on the webpage. This implements interaction between the user and multiple network platforms, and thereby provides more ways in which the user interacts with the network platforms.

It should be noted that, the server and the network platform provided in this embodiment are described by using the division of the functional modules as an example. In actual application, the functions may be implemented by different functional modules according to actual requirements. That is, the internal structures of the server and the network platform are divided into different functional modules to implement all or a part of functions described above. In addition, the server and the network platform provided in this embodiment are based on the same inventive concept as embodiments of the method for interaction. Therefore, the detailed implementation can refer to the description of the method embodiments of the present disclosure, which is not described herein any further.

The sequence numbers of the preceding embodiments of the present disclosure are only for ease of description, but do not denote the preference of the embodiments.

Persons of ordinary skill in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A method for interaction, comprising:
acquiring a task link that is clicked by a user on a first network platform, wherein the task link corresponds to a preset task on a second network platform;
redirecting, according to the task link, to a webpage wherein the preset task on the second network platform is located; and
implementing the preset task on the webpage.

2. The method according to claim 1, wherein before the redirecting, according to the task link, to a webpage where the preset task on the second network platform is located, the method further comprises:
authenticating whether the user is qualified to perform the preset task on the second network platform; and if the user is qualified, performing the step of redirecting, according to the task link, to the webpage where the preset task on the second network platform is located.

3. The method according to claim 1, wherein after the redirecting, according to the task link, to a webpage where the preset task on the second network platform is located, the method further comprises:
charging a first fee corresponding to the preset task on the second network platform according to pre-stored account information corresponding to the second network platform.

4. The method according to claims 1, wherein after the redirecting, according to the task link, to a webpage where the preset task on the second network platform is located, the method further comprises:
acquiring a reward acquiring request from the first network platform, wherein the reward acquiring request is generated according to a reward option clicked by the user on the first network platform after performing the preset task on the second network platform, and the reward option corresponds to the preset task on the second network platform; and
returning a reward corresponding to the reward option to the user according to the reward acquiring request.

5. The method according to claim 4, wherein before the returning a reward corresponding to the reward option to the user according to the reward acquiring request, the method further comprises:
authenticating whether the user is qualified to acquire the reward corresponding to the reward option; and if the user is qualified, sequentially performing the step of returning the reward corresponding to the reward option to the user according to the reward acquiring request.

6. The method according to claim 4, wherein after the returning a reward corresponding to the reward option to the user according to the reward acquiring request, the method further comprises:
charging a second fee corresponding to the preset task on the second network platform according to the pre-stored account information corresponding to the second network platform.

7. A server, comprising:
a first acquiring module, configured to acquire a task link that is clicked by a user on a first network platform, wherein the task link corresponds to a preset task on a second network platform; and
a redirecting module, configured to redirect, according to the task link acquired by the first acquiring module, to a webpage where the preset task on the second network platform is located; and implement the preset task on the webpage.

8. The server according to claim 7, further comprising:
a first authenticating module, configured to authenticate whether the user is qualified to perform the preset task on the second network platform; and if the user is qualified, the redirecting module performs the step of redirecting, according to the task link, to the webpage where the preset task on the second network platform is located.

9. The server according to claim 7, further comprising:
a first charging module, configured to charge a first fee corresponding to the preset task on the second network platform according to pre-stored account information corresponding to the second network platform.

10. The server according to claims 7, further comprising:
a second acquiring module, configured to acquire a reward acquiring request from the first network platform, wherein the reward acquiring request is generated according to a reward option clicked by the user on the first network platform after performing the preset task on the second network platform, and the reward option corresponds to the preset task on the second network platform; and
a returning module, configured to return a reward corresponding to the reward option to the user according to the reward acquiring request acquired by the second acquiring module.

11. The server according to claim 10, further comprising:
a second authenticating module, configured to authenticate whether the user is qualified to acquire the reward corresponding to the reward option; and if the user is qualified, the returning module performs the step of returning the reward corresponding to the reward option to the user according to the reward acquiring request.

12. The server according to claim 10, further comprising:
a second charging module, configured to charge a second fee corresponding to the preset task on the second network platform according to the pre-stored account information corresponding to the second network platform.

13. A method for interaction, comprising:
displaying at least one task link corresponding to a preset task on a second network platform;
upon detecting that a user clicks the displayed task link, sending the task link clicked by the user to a server, whereupon the server redirects, according to the task link clicked by the user, to a webpage where the preset task on the second network platform is located; and
implementing the preset task on the webpage.

14. The method according to claim 13, further comprising:
displaying at least one reward option corresponding to the preset task on the second network platform; and
wherein after the sending the task link clicked by the user to a server, the method further comprises:
sending a reward acquiring request to the server according to the reward option clicked by the user, such that the server returns a reward corresponding to the reward option according to the reward acquiring request.
